(19) United States
(12) Patent Application Publication
(10) Pub. No.: US 2013/0338919 A1
(43) Pub. Date: Dec. 19, 2013

(54) USER-CENTRIC PLATFORM FOR DYNAMIC MIXED-INITIATIVE INTERACTION THROUGH COOPERATIVE MULTI-AGENT COMMUNITY

(71) Applicant: INTELLIGENT MECHATRONIC SYSTEMS INC., Waterloo (CA)

(72) Inventor: Otman A. Basir, Waterloo (CA)

(73) Assignee: INTELLIGENT MECHATRONIC SYSTEMS INC., Waterloo (CA)

(21) Appl. No.: 13/690,601

(22) Filed: Nov. 30, 2012

Related U.S. Application Data
(60) Provisional application No. 61/565,164, filed on Nov. 30, 2011.

(51) Int. Cl. H04L 29/08; G01C 21/00

(52) U.S. Cl. CPC H04L 67/12; G01C 21/00
USPC 701/537; 709/202

(57) ABSTRACT

A user-centric vehicle platform may include an in-vehicle device. A user portal remote from the in-vehicle device provides a plurality of user agents communicating with the in-vehicle device.

### BACKGROUND

Conventional operating systems are designed to provide a foundation to simplify basic file and process operations including persistent storage, starting and stopping processes, I/O with peripherals, and communication between processes. The focus and purpose of conventional operating systems is to abstract complex hardware to service processes, including managing available hardware and resources between multiple processes.

### SUMMARY

A complementary platform or operating layer provides an environment to simplify fundamental human machine interaction (HMI) activities. The dynamic and complex nature of human machine interaction is abstracted and directly managed by this platform, from signal processing through to discourse management. This platform delivers services to HMI applications and processes, each of which can use varying levels of detail to deliver user-centric value. The user-centric vehicle platform may include an in-vehicle device. A user portal remote from the in-vehicle device provides a plurality of user agents communicating with the in-vehicle device.

### BRIEF DESCRIPTION OF THE FIGURE

FIG. 1 is a schematic of the user-centric platform according to one embodiment of the present invention.

### DESCRIPTION OF A PREFERRED EMBODIMENT

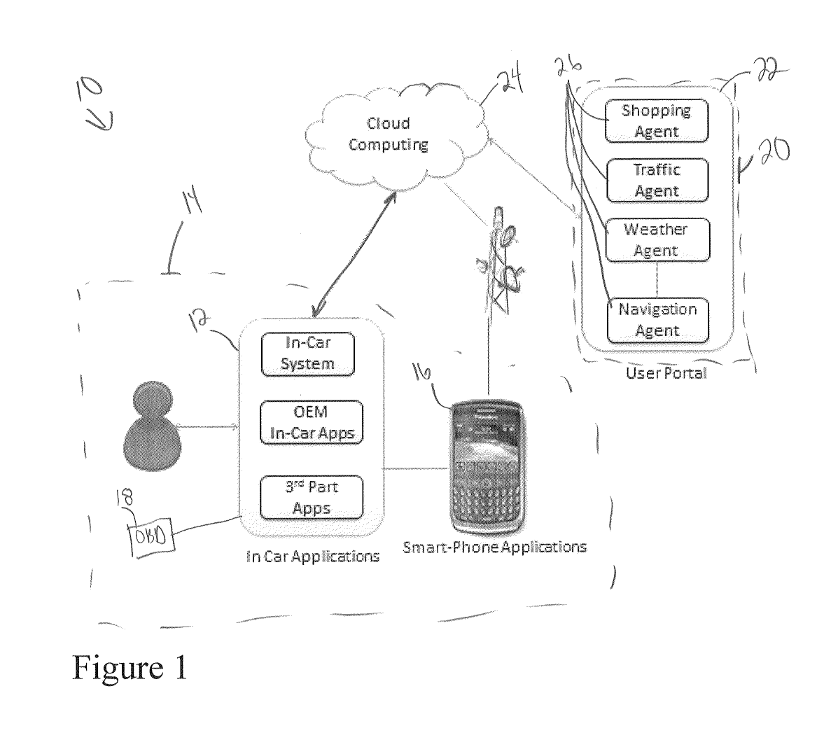

A user-centric platform 10 is shown schematically in FIG. 1. As explained below, the platform 10 is largely independent of the specific hardware used for its implementation; however, as an example, the platform 10 may include an in-vehicle device 12 or control unit installed (or as original equipment in) a vehicle 14. The in-vehicle device 12 communicates with a mobile communication device 16 (such as a smart phone), either via a hard connection or preferably via a wireless communication (such as Bluetooth). The in-vehicle device 12 and mobile communication device 16 each include a processor, electronic storage, appropriate communication circuitry and are programmed to perform the functions described herein. The in-vehicle device 12 may include position-determining hardware (such as a GPS receiver or other receiver of satellite information that indicates position) or the in-vehicle device 12 may receive position information from such hardware on the mobile communication device 16. The in-vehicle device 12 may also receive vehicle information from a vehicle bus, such as an on-board diagnostics port 18 (such as OBD, OBDII, CAN, or similar).

The in-vehicle device 12 communicates via cell towers over a wide area network, such as the internet, with a server 20 providing a user portal 22. The server 20 could include one or more processors, electronic storage, suitably programmed and could be implemented via cloud computing 24. The user portal 22 provides a plurality of user agents 26. The user agents 26 are agents for the user. They act on behalf of the user to persist, collect contextually relevant information, synthesize, and use to inform the user, and add intelligence to the interaction. Agents 26 are typically autonomous, or semi-autonomous so they can continue to work toward their goals without direct human intervention.

Again, the platform 10 is largely independent of the specific hardware used for its implementation. A complementary platform or operating layer provides an environment to simplify fundamental human machine interaction (HMI) activities. The dynamic and complex nature of human machine interaction is abstracted and directly managed by this platform, from signal processing through to discourse management. This platform 10 delivers services to HMI applications and processes, each of which can use varying levels of detail to deliver user-centric value.

User-aware multi-process management: Multiple processes and applications can be hosted and co-exist within the platform 10, each using the underlying platform services to accomplish a specific HMI related task. These tasks may be as diverse as the acquisition of relevant traffic and congestion information to a tire pressure warning to the delivery of a requested song. With multiple applications, one challenge is managing the flow of information between these applications often competing for the same small set of available physical interfaces with the user. Proper platform management of these multiple applications ensures the delivery of a coherent interface with intelligible content. For example, the platform does not arbitrarily switch between one speech-generating application and another to create abrupt mid-sentence changes, but determines the most appropriate time based on the context of the current human-interaction activities and state of each application.

The platform 10 unifies the management of tasks/applications on the user's smartphone 16, on a cloud backend 24, and/or tasks/applications executable on OEM installed applications on the in-vehicle device 12.

The behavior of the platform 10 is location and context sensitive. The applications' behavior will depend on the location of the in-vehicle device 12 executing the platform 10. For example, the type of application that will be in the forefront of the platform 10 will depend on whether the in-car system and/or smart-phone happens to be in a highway or the downtown of the city. Furthermore, forefront applications may be disabled and enabled based on the in-car system and/or smart-phone location. The behavior of the application can be location sensitive in the sense that the type of interaction with the user can be different if the in-car system and/or smart-phone is on a highway versus downtown to maximize safety. The platform 10 will adjust its behavior to personalize to the specific needs of the user. For example, a navigation application will compute routes on knowledge of the user preferences (user does not like highways and prefers scenic country roads; prefers routes that avoid downtown areas, etc.). User preferences can be explicitly programmed by the user or are determined based on monitoring user habits. The behavior of the applications can be sensitive to the speed of the car hosting the platform 10 on the road and/or the distance between the hosting car and the car in front of it.

The platform 10 employs a software agent community on each user portal that either runs on the platform 10 itself or on a cloud backend via a wireless connection. Each agent on the portal can be assigned by the user to a specific task to perform. The agent and the user interact via voice and/or other HMI means.

Users can choose to expose all or some of their respective agents to each other. Once an agent of a user is exposed to another user, the other user can enable communication and information sharing between both user agents (exposed agents).

The user can create an agent on his/her portal. The behavior of the agent can be defined by the user.

The portal 22 offers a community of typically used agents (standard agents). The user can adjust the behavior of his/her standard agents to personalize them to his/her specific needs.

Behavioral aspects of the agent may include but not limited to:
Agent name
Agent gender
Agent actuation: from the car by the user (e.g, menu item on the portal 22), on user detection in the car; other external events (e.g, event such as time on the portal, message from another agent of the user agents; or message from an agent of another user; location of the in-car system and/or smart-phone).
Agent actions: actions the agent takes once actuated.
Agent to user delivery rules: for example deliver to my car if I am in the car; otherwise to my smartphone; remind until you receive acknowledgement;
Agent to Agent cooperation: you can get information from users x,y,z and you can share information with users a,b,c.

Every time the user gets into the car the platform 10 sends an alert to the portal agents.

The platform 10 will feed the current location of the hosting car regularly.

The behavior of the agent is sensitive to the location of the hosting car, the presence of the user in the car as well the specific task the user wants the agent to perform. For example, the user can program the shopping agent to search for an article the user wants to buy. In this case as soon the user gets in to the car the shopping agent will start the search for the item on the user path. Once the item is found the user informed on the in-car system or on the user smartphone (the smartphone can be deduced on last location of hosting platform 10 or smartphone reported location via GPS, GPRS triangulation, etc.).

The portal traffic agent can be programmed by the user on routes the user normally takes in his/her travel. These routes can be updated based on information provided by the platform 10 to the agents based on newly created routes on the hosting vehicle navigation system.

The portal traffic agent, as soon as it detects the user is in the car, based on the current location of the hosting vehicle it deduces the route being followed. Based on this information the agent will scan the route to determine any traffic events (accidents, traffic jams, road closure, etc.). Such events are reported to platform 10 and consequently to the user. If routes are not known to the agent, then the agent will make decisions on traffic events relevant to the user based on vehicle location and/or frequent travel paths of the user in the area.

The traffic agent can receive messages or sms messages from the user containing information about a travel destination. The agent will use this information to determine a route/path from the present vehicle location and the destination and will initiate a traffic monitoring process to determine traffic flow on the path and to determine the occurrence of events along the path that may cause delays to the trip of the user on the path. The expected arrival time and trip time are dynamically updated and communicated to the user on the in-vehicle device 12.

The traffic agent will maintain statistical information on all routes the user has entered or the agent has constructed. These statistics include, average trip time on the path, event occurrence frequency, event severity level. These routes can be shared with agents of other users.

The user can program the reminder agent to remind the user to perform tasks based on a combination of time (day, date, etc) and location (could be address, or location category such as gas station, grocery store parameters). The agent will alert the user via the in-car system once these conditions are satisfied. For example, the user can program the agent to remind the user to buy a coffee as soon as the agent determines the user is in the vicinity of a coffee shop. The agent is intelligent enough to perform reasoning to determine that a coffee can be also be available for purchase in a gas station. The user can choose not to specify a specific location or location category. The agent will perform task to location category association to determine locations in the area that can satisfy the reminder conditions. For example, the user may ask the agent to remind the user to buy milk. As the user moves on the path, the agent processes location categories on the path to see if there is any location that can satisfy the condition (e.g, gas stations, grocery store, a coffee shop, etc).

Agents may keep track of the user choices to determine a common trend that it uses to make clever decisions. For example, the traffic agent will keep track of repetitive routes to determine routes of interest and areas of interest and will use that information to make decisions on informing the user about these routes and areas with respect to traffic. As another example, the stock agent learns from usage that the user is interested in technology stocks, so it can decide to feed the user information on a stock that was not in the user's portfolio. As another example, the entertainment agent (music and movies) can choose to offer the user news on a specific artist if it determines that the user often listen to this type of music or artist. The user can create a library of music and/or video on the portal. Once in the car the user can choose to browse remotely through this library and is allowed to play any one of this library items in the car. It can, for another example, alert the user about an event relevant to the user's frequent activities. The agents may be in the cloud working behind the scene, as the user is driving, the agents are proactively delivering in a smart way content to the user in the car as it pertains to the user's location and the user's habits.

Two users and more can share their agent communities. This will allow one user to take advantage of experience learned by the agents of other users. In this case the agent of one user will exchange decisions with the agent of the other user so as to ensure both agents coordinate to achieve a common goal. For instance, two users can combine their traffic agents. In this case the agent of one user will communicate information on traffic of one user to the agent of the other user. The other user can choose to inform its user that the first user is going through traffic jam. In this case this user will be aware of delay the other user is expected to have as a result of this jam.

By choosing a common agent to perform a common task, the two users will be treated by the agent as if they were one user. For instance, if two users choose one traffic agent, the agent decisions and alerts are communicated to both users.

The internet-radio agent: The user can interact with the portal to create and launch an internet radio agent. The internet-radio agent will learn channels the user wants to listen to while commuting. For example, the user may inform the agent that the user likes listening to BBC, CNN, Aljazeera, Japanese channel. The user can customize the names of these choices to reflect his personal liking. As soon as it is informed by the in-vehicle device 12 that the user has entered the car, the agent causes the platform 10 to configure its internet radio program to reflect the choices the user has entered on the portal. The platform 10 will interact with the user with respect to these choices using their default names or the customized names.

The internet radio agent will monitor the web site of each radio channel to determine if breaking news or other exciting events occurred so that the user is informed of such breaking news or events.

Similarly, the agent will allow the same treatment of RSS feeds.

The music streaming agent: The portal provides an agent that the user can use to create a set of music content records. The set will be stored on the portal. A titles list will be created and communicated to the in-vehicle device 12 as soon the agent is informed of the user entering the vehicle so that the user can interact with the platform 10 to play the records associated with these titles while in the vehicle.

The music streaming agent will monitor the internet to determine if any new releases by an artist of an existing record or by an artist the user is interested in. Once a new release is detected the user is informed as soon as the user signs on to the portal. Alternatively, the agent will inform the user using an email or sms message, or a note on the portal.

Book Reader Agent: the user is able to interact with books in a similar way as music by a book reader agent.

The stock agent: The user can use this agent on the portal to create a list of all stocks the user wants to monitor. The user can customize the name as it suits his/her liking, for example, the user may choose to name the “RIM Stock” “Research in Motion Stock” or “blackberry stock.” The agent will monitor the stocks and based on a user specified threshold on trading value fluctuating. The agent will configure the in-vehicle device 12 to interact with the user on these stocks so as to answer the user question on stock quotes. Furthermore, the user will be immediately informed of any stock change events based on the thresholds specified by the user on the platform 10.

The user can use the in-vehicle device 12 to inform the stock agent that he wants to sell or buy a certain stock. The agent will either take this action if this feature is enabled on the portal, alternatively, a message is sent on behalf of the user to the user's broker with optional voice recording of such instruction from the user for confirmation and documentation purpose.

Goal-driven prioritization: As a user-centric platform 10, applications are prioritized based on their relevance to the user's current goals, their capability to achieve current goals, and the urgency of each of these. For example, an application that manages historical news feeds may be lowered in priority or even suspended to ensure another application that has an urgent email that the user has been expecting can be delivered in a timely manner. It is important to note that prioritization is always balanced against the natural flow of information, each application is aware of its status and relative priority:
If a user initiated interruption is detected, an opportunity exists to immediately readjust and interact with a new application.
If the user is already reading or listening to content deemed urgent by another application, the platform 10 may queue up the urgent email for delivery when the user finishes interacting with the first application.
An application, when blocked waiting for interaction with the user, may use the platform 10 to deliver “mixed” signals or hints that can safely be delivered to the user through alternate channels. Examples include mixing audio signals to deliver a “background audio clip” while speech is in progress, or delivery of a visual indicator.
In other scenarios, a high priority interruption for an upcoming traffic accident may immediately interrupt the current application to ensure the safety-related information is known to the user as soon as possible.

Adaptive personalization: HMI processes and applications are interchangeable at runtime, allowing the behavior of the system as perceived by the user to be modified during interaction. Interchangeable processes allow the platform 10 to deliver a completely different experience for two different people, in addition to supporting new experiences through local, remote, or over-the-air deployment of individual HMI processes and applications.

HMI hooks: The complete flow from machine sensing of human expression through to the delivery of content can be passively monitored by applications, or applications can invasively splice into the flow to consume, process, modify, and inject as desired. This capability allows the user-centric platform 10 to support applications or plugins for language translation, applications that trigger on keywords or sift through interactions to automatically generate minutes, and applications that complement and build on one another rather than execute in isolation.

Relationship to existing operating systems: Since this platform 10 abstracts human-machine-interaction, it can exist in a complementary form alongside existing operating systems that abstract hardware, across multiple conventional operating systems, and independent of a conventional operating system in an embedded form. Where a conventional operating system may have an event for a low memory condition (hardware/physical platform-centric), the platform 10 described here may have an event for “Dave just arrived/is now present” or “new user request: Call him back.” (user-centric).

Distributed presence: The user-centric platform 10 may reside on one or more physical systems where available and permitted to help deliver an optimal user experience. This includes use of mobile/smartphone platforms for quick (battery-aware) interactions, use of online computational resources for complex content manipulation, and use of in-vehicle platforms for vehicle specific interaction. Applications can migrate from one physical system to another to follow the user to provide a base level of consistency. In scenarios where multiple physical systems are available, they can be used in combination with one another to augment computational resources (in-vehicle+online), to augment human interfaces (in-vehicle for audio/visual+smartphone for vibration/ring), or to provide redundancy and simplify transitions as the user moves from one set of systems to another.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers for steps in method claims are for ease of reference in dependent claims and do not signify a required sequence unless otherwise stated.

What is claimed is:

1. A user-centric vehicle platform:
an in-vehicle device; and
a user portal remote from the in-vehicle device, the user portal providing a plurality of user agents communicating with the in-vehicle device.

2. The user-centric vehicle platform of claim 1 wherein the plurality of user agents are user-customizable.

3. The user-centric vehicle platform of claim 1 wherein the plurality of user agents act on behalf of the user.

4. The user-centric vehicle platform of claim 1 wherein the plurality of user agents are configured to communicate with user agents of another user.

5. The user-centric vehicle platform of claim 1 wherein the in-vehicle device communicates with a mobile communication device of the user.

6. The user-centric vehicle platform of claim 1 wherein at least one of the user agents receives location information indicating a current location of the in-vehicle device and wherein the at least one user agent acts based upon the location information.

7. The user-centric vehicle platform of claim 1 wherein at least one of the plurality of user agents receives presence information indicating a presence of the user in the vehicle and acts based upon the presence information.

8. The user-centric vehicle platform of claim 1 wherein one of the plurality of user agents is a navigation agent, one of the user agents is a shopping agent and one of the user agents is a traffic agent.

9. The user-centric vehicle platform of claim 1 wherein one of the plurality of user agents is an internet radio agent.

10. The user-centric vehicle platform of claim 1 wherein one of the plurality of user agents is a music agent.

11. The user-centric vehicle platform of claim 1 wherein the platform prioritizes and queues communications from the plurality of user agents to the user relative to one another.

12. The user-centric vehicle platform of claim 1 wherein the plurality of user agents monitor a human-machine interface and execute actions based upon triggers in the human-machine interface.

13. A method for providing user-centric interaction:
receiving customization of a plurality of user agents at a computer remote from a user; and
the plurality of agents acting on behalf of the user on the computer remote from the user.

14. The method of claim 13 wherein at least one of the plurality of user agents is configured to communicate with a user agent of another user, wherein the user agent of the another user is also at the computer which is also remote from the another user.

15. The method of claim 13 further including the step of the plurality of user agents receiving information from a mobile communication device of the user.

16. The method of claim 13 further including the steps of at least one of the plurality of user agents receiving location information indicating a current location of the user and the at least one of the plurality of user agents acting based upon the location information.

17. The method claim 13 further including the steps of at least one of the plurality of user agents receiving presence information indicating a presence of the user in a vehicle and acting based upon the presence information.

18. The method of claim 13 further including the steps of: one of the plurality of user agents providing a navigation route to the user, one of the plurality of user agents shopping for the user and one of the plurality of user agents monitoring traffic for the user.

19. The method of claim 13 further including the step of one of the plurality of user agents monitoring internet radio for the user.

20. The method of claim 13 further including the step of one of the plurality of user agents selecting music for the user.

21. The method of claim 13 further including the step of prioritizing and queuing communications from the plurality of user agents to the user relative to one another.

22. The method of claim 13 further including the steps of the plurality of user agents monitoring a human-machine interface and executing actions based upon triggers in the human-machine interface.
